(19) United States
(12) Patent Application Publication
(10) Pub. No.: US 2005/0003692 A1
(43) Pub. Date: Jan. 6, 2005

(54) I/O expansion system and a connector therefor

(76) Inventor: Richard Allirot, Meylan (FR)

Correspondence Address: HEWLETT-PACKARD COMPANY;Intellectual Property Administration, P.O. Box 272400, Fort Collins, CO, 80527-2400, US

(21) Appl. No.: 10/782,068

(22) Filed: Feb. 19, 2004

(30) Foreign Application Priority Data
Feb. 21, 2003 (EP) 03290430.2

(51) Int. Cl. H01R 13/62

(52) U.S. Cl. 439/160

(57) ABSTRACT

An I/O expansion system comprises a female connector for operative connection to a baseboard, and an add-in card having a male connector on a first edge for receipt by the female connector and a notch for receipt of a retention formation of the connector. It further includes a carriage part movable along the length of the female connector and providing support for the retention formation.

### FIELD OF THE INVENTION

The invention relates to an I/O expansion system of the kind used, for example, to provide interconnection between peripherals and the baseboard or mother board in personal computers, servers and the like.

### BACKGROUND OF THE INVENTION

It is common in personal computers (PCs), servers and the like for add-in cards, also called expansion cards, to be used to provide interconnection between peripherals and the baseboard or mother board. Such add-in cards have, along all or more normally part of a first edge, a male edge connector formed from edge fingers (sometimes called “gold fingers”) for insertion into a female connector provided on the baseboard. On a second edge, generally at right angles to the first edge, the add-in cards have a portion which fixes to the chassis of the PC or server at the location of a slot therein such that a further connector is accessible from the exterior of the PC or server for connection of the peripheral.

Clearly it is desirable to ensure good retention of the add-in card male edge connector in the female connector on the baseboard, in order to ensure that the add-in card is correctly connected electrically to the PC or server at all times. If the add-in card is simply retained in the female connector by means of the pressure applied to the edge fingers by the electrical contacts it does not have very good resistance to shock or vibration, and therefore it is preferable to provide some kind of additional retention device in such connection systems. In the prior art this has been achieved by a variety of means.

One prior art solution, defined in the “AGP Card Retention Specification” Rev 1.0 dated 12 Sep. 1998 issued by Intel Corporation, uses a small resilient retention tab located on one end of the female connector, and a co-operating notch cut into the side of the add-in card.

Another prior art solution, used in Hewlett Packard motherboards, uses a small rotatable lever located at one end of the female connector, which is rotated upwardly and inwardly with respect to and in the plane of the add-in card, once that is inserted in the female connector, to engage with a notch on the add-in card.

The above described retention devices are both for use with prior art connectors and add-in cards where the edge-fingers of the add-in card form a male edge connector of the same length as the female connector, such that edge-fingers fill the female connector. However, a new standard has recently been developed under the name “3GIO”, which has been released under the name PCI Express, by the PCI Special Interest Group. (Details may be obtained from their website www.pcisig.com). Under this standard the male edge connectors of add-in cards will have a variable number of edge-fingers, depending on the bandwidth of the card, and hence be of different lengths. In the prior art this would have meant female connectors of different lengths for receipt of the different add-in cards. However, under this standard a single design of female connector will be able to accept different lengths of male edge connector. Specifically the female connectors will be able to act as 1 port, 2 port, 4 port or 16 port connectors, and thus be able to receive four different lengths of male edge connector. There is therefore now a need for a retention device which can be used with the different add-in card and female connector combinations.

One proposal for such a retention device (included in “3GIO Evolutionary Electro-Mechanical Specification, Rev. 1.0 Draft” issued by the PCI Special Interest Group) includes an elongate retention clip having a hook at a first end, and in a mid region a narrow deformable bridge to a push in plug. The push in plug is received in a hole in the add-in card with the clip oriented with the hook adjacent the male edge connector. The female connector or a cover thereof includes a laterally extending ridge along one side, such that when the add-in card is inserted into the female connector the hook of the clip rides out and over the ridge, by deformation of the narrow bridge, and then engages beneath the ridge to retain the add-in card in the female connector. To release the add-in card the second end of the clip, distant from the hook, is pushed inwardly towards the add-in card, deforming the narrow bridge and disengaging the hook from the ridge.

The ridge is provided along the entire length of the female connector and therefore the clip can be attached to any location on the add-in card along the length of the male edge connector. Hence the solution is applicable to add-in cards using any of the possible male edge connector lengths. However, this solution suffers from the disadvantage of increased resistance during insertion of the add-in card as discussed above. In addition it also suffers from the disadvantage that the clip occupies space on the add-in card, which is clearly undesirable.

It is an object of the present invention to provide alternative and preferably improved add-in card connection systems for use in such situations.

### SUMMARY OF THE INVENTION

According to a first aspect of the present invention there is provided an I/O expansion system comprising:
a female connector for operative connection to a baseboard, and
an add-in card having a male connector on a first edge for receipt by the female connector and a notch for receipt of a retention formation of the female connector,
wherein it further includes a carriage part movable along the length of the female connector and providing support for the retention formation.

The system preferably further includes on a surface of the carriage part the female connector a locking formation, and on an outer surface of the female connector a plurality of cooperating locking formations spaced apart along the length of the female connector, such that the carriage part is lockable with respect to the female connector at a plurality of positions along it's length.

The carriage part may include a recess in it's upper surface into which in use an edge of the add-in card is received.

Conveniently the locking formation on the carriage part is a protrusion, and the locking formations on the female connector are recesses.

The retention formation may be pivotable between an operative position in which the retention formation is within the notch on the add-in card and acts to retain the add-in card in the female connector and an inoperative position in which the retention formation is free of the notch on the add-in card and the add-in card can be removed from the female connector.

Such embodiments may further include an arm connected with the retention formation for pivoting of the retention formation between the operative and inoperative positions.

Conveniently the arm is pivotally secured to the carriage part by a pivot pin and the retention formation is carried on the pivot pin, and the retention formation may be hook shaped.

In alternative embodiments the carriage part includes an upwardly extending arm and the retention formation is an inwardly extending protrusion from the upwardly extending arm.

In such embodiments the upwardly extending arm may be resiliently deformable and the retention formation has a cam surface on its upper side such that when the add-in card is inserted into the female connector the upwardly extending arm bends outwardly to permit the retention formation to ride over a leading edge of the notch and then into the notch to the retain the add-in card in the female connector.

Conveniently in such cases the upwardly extending arm has an outwardly angled upper portion.

When the female connector includes a housing which supports a plurality of electrical contacts, and the co-operating locking formations spaced apart along the length of the female connector may be provided on an outer surface of the housing.

In such embodiments the carriage part is substantially “U” shaped.

When the female connector includes a housing which supports a plurality of electrical contacts, and a cover which increases the width of the female connector towards it's upper surface, and the co-operating locking formations spaced apart along the length of the female connector may be provided on an outer surface of the cover

In such cases the carriage part is substantially “C” shaped, and is retained on the female connector by engaging beneath the cover.

According to a second aspect of the invention there is provided a female connector for an I/O expansion system according to the first aspect of the invention.

According to a third aspect of the invention there is provided a female connector specifically adapted for both operative connection to a baseboard and receipt of a male edge connector of an add-in card, wherein it includes a carriage part movable along the length of the female connector and providing support for a retention formation specifically adapted to engage in use with a formation on the add-in card to retain the male edge connector of the add-in card in the female connector.

### BRIEF DESCRIPTION OF THE DRAWINGS

Embodiments of the invention will now be described, by way of example only, with reference to the accompanying drawings in which:

FIG. 1 illustrates in perspective a female connector and retention device;

FIG. 2 is a cross section through line A-A of the female connector of FIG. 1;

FIG. 3 illustrates add-in cards having a) a 2-port male edge connector, and b) a Sport male edge connector, respectively;

FIG. 4 illustrates the I/O expansion system of the invention with a) an add-in card retained in the female connector and b) the retention device released and the add-in card being removed from the female connector; and

FIGS. 5 & 6 illustrate an alternative embodiment of retention device for such I/O expansion systems, in perspective and cross-section respectively.

### DETAILED DESCRIPTION OF THE PREFERRED EMBODIMENTS

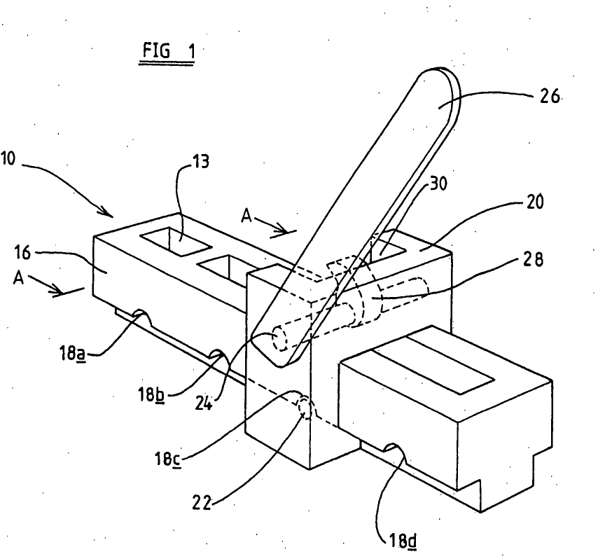

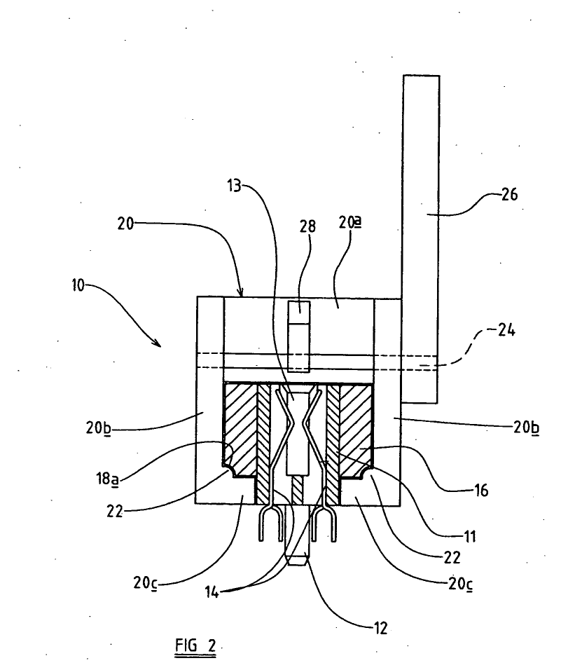

Referring first to FIGS. 1 and 2, a female connector 10, for operative connection to a baseboard (not shown), is illustrated in perspective and in cross section respectively. The female connector 10 comprises, as in the prior art, a housing 11 which supports a plurality of pins 12 for physically securing the female connector 10 in use to a baseboard, and defines a slot 13 within which are located a plurality of pairs of electrical contacts 14 spaced apart along it's length. Each pair of electrical contacts 14 is specifically adapted for receipt between their upper ends of an edge-finger of a male edge connector of an add-in card as will be described later, and for electrical connection to the baseboard at their lower ends. When the female connector 10 is mounted on a baseboard the housing 11 sits on or very close to the surface of the baseboard.

Partially surrounding the housing 11, is a cover 16 which increases the width of the female connector 10 towards it's upper surface, but does not extend downwards to the bottom part of the housing 11, thus providing an overhang. Four pairs of recesses 18, with one recess of each pair located on each side of the cover 16, are spaced apart along the lower surface of the cover 16. The first pair of recesses 18a relate to a 1-port portion of the female connector 10, the second pair 18b to a 2-port portion of the female connector 10, and the third and fourth pairs 18c and 18d to 4-port and 16-port portions respectively, as will become clearer later.

The female connector 10 further comprises a carriage part 20 which is generally “C” shaped having a top part 20a, a pair of side parts 20b and a pair of bottom end parts 20c. It is shaped in cross section, as best seen in FIG. 2, to be a sliding fit around the cover 16, such that once slid onto the end of the female connector 10 it is retained on the female connector 10 by the bottom end parts 20c passing under the cover 16. A pair of protrusions 22 is provided on the inner corners at the joins of the side parts 20b to the bottom end parts 20c. The protrusions 22 are sized to fit within the recesses 18 on the cover 16. The carriage part 20 is made from a material which can be slightly resiliently deformed, such that the side parts 20b can bend slightly outwardly to allow the protrusions 22 to pass along the parts of the cover 16 without the recesses 18. Thus the carriage part 20 can be moved along the female connector 10 and locked in any one of four positions when the protrusions 22 locate in a respective pair of recesses 18.

The top part 20a of the carriage part 20 is itself generally “U” shaped, having a recess 30 which in use faces towards the add-in card and receives the add-in card.

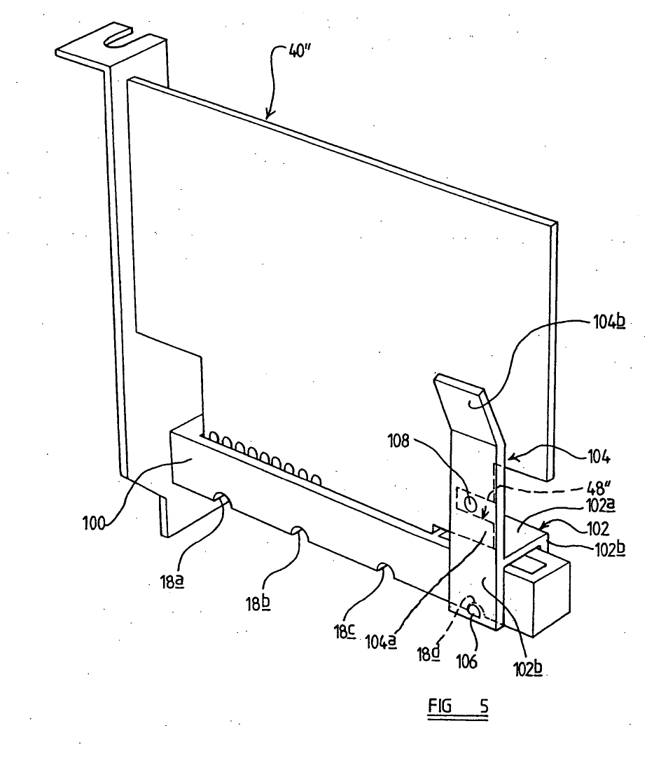

The carriage part 20 has pivotally secured to one side part 20b, by means of a pivot pin 24, an arm 26. A retention formation 28 is provided on the pivot pin 24 located above the slot 13. The arm 26 can be pivoted between an operative position (shown in FIG. 4a) and an inoperative position (shown in FIG. 4b, as will be discussed further below.

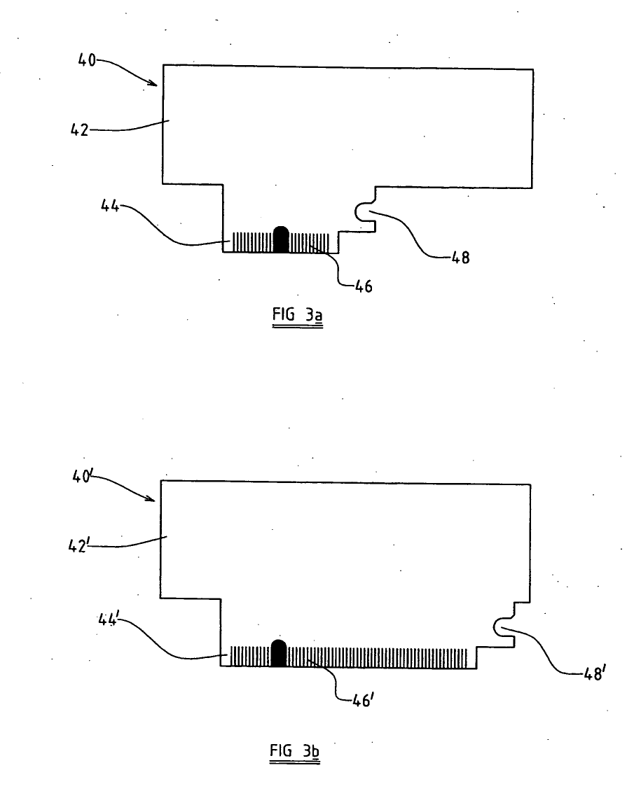

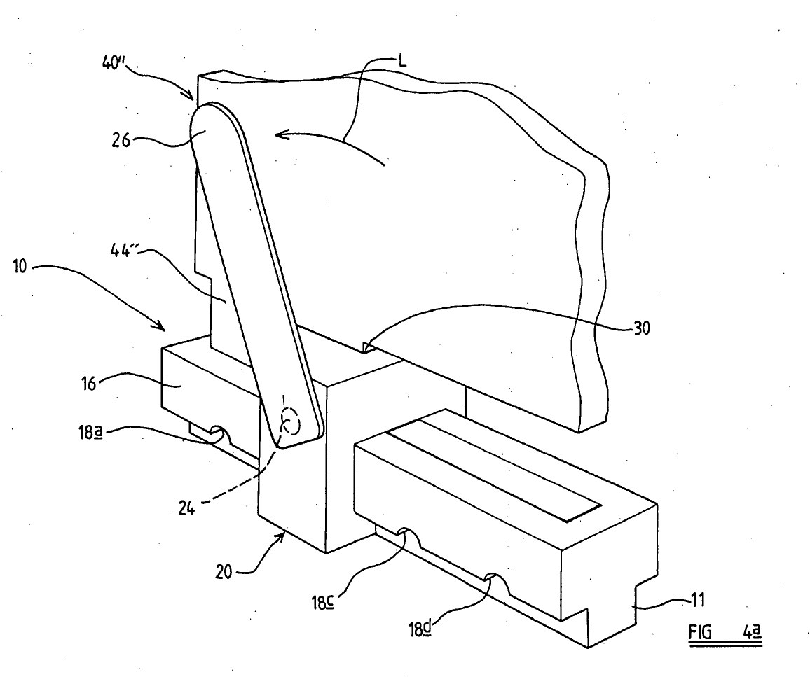

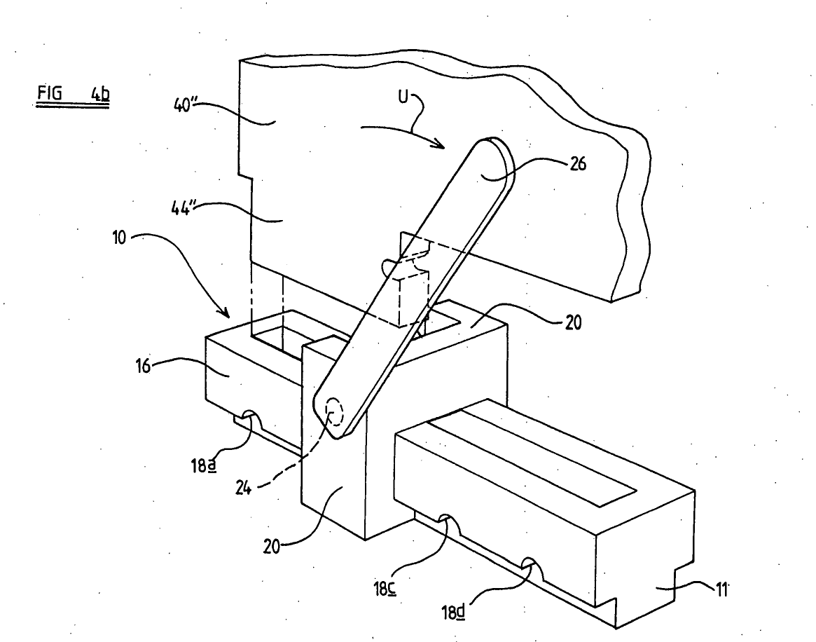

Referring now to FIG. 3, two add-in cards 40, 40′ are simply illustrated. Add-in card 40 has a main body 42, male edge connector 44, comprised of a plurality of edge-fingers 46, of an appropriate length for use of a 2-port portion of the female connector 10. At the right hand end of the male edge connector 44, and also located below the main body 42, is a sideways oriented notch 48 of a size suitable for receipt of the retention formation 28 on the pivot pin 24. Add-in card 40′ is similar to the add-in card 40, with the exception that the male edge connector 44′ is of an appropriate length for use of a 16-port portion of the female connector 10.

Referring now to FIG. 4 the I/O expansion system is shown in use. In FIG. 4a) an add-in card 40″, with a male edge connector of 4-port length, is shown inserted into the female connector 10. Following insertion of the add-in card 40″ into the female connector 10, the carriage part 20 has been moved along the cover 16 of the female connector 10 to lock in the 4-port position, in which position the add-in card 40″ is received in the recess 30. The arm 26 has then been pivoted, as indicated by arrow L to the left, into it's operative position thus bringing the retention formation 28 into the notch 48″ and retaining the add-in card 40″ securely within the female connector 10.

Removal of the add-in card 40″ is a simple process, this being the reverse of the above. The arm 26 is pivoted to the right, as shown by arrow U in FIG. 4b), to remove the retention formation 28 from the notch 48″. The add-in card 40″ can then be pulled upwards out of the female connector 10. If desired the carriage part 20 of the connector 10 can be moved away from the add-in card 40″ during this process, but this is not necessary for the removal of the add-in card 40″.

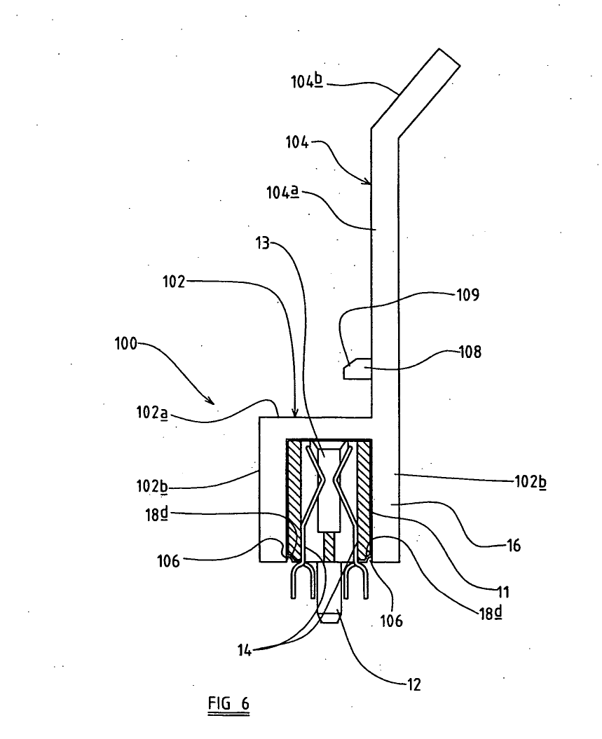

Referring now to FIGS. 5 and 6 an alternative form of female connector 100 is illustrated. It is similar to the connector 10, and like parts are like referenced. However, in this case there is no additional cover over the housing 11, and the recesses 18 are simply provided in the sides of the housing 11. In addition, the carriage part 20 and pivoting arm 26 are replaced by a different form of carriage part 102 with a resiliently deformable arm 104 which is preferably moulded integrally with the carriage part 102. The carriage part 102 has a top part 102a and side parts 102b and protrusions 106 are provided on the inner surfaces of the side parts 102b for co-operation with the recesses 18 as described above.

The resiliently deformable arm 104 is an upward extension of one side part 102b, and has a first portion 104a which has on its inner surface a retention formation 108 and at it's upper end an outwardly angled portion 104b. The retention formation 108 comprises a peg with a cam surface 109 uppermost such that when the carriage part 102 is in the desired position and the add-in card is inserted into the female connector 100 the leading edge of notch 48″ pushes the retention formation 108 and thus the arm 104 outwardly to allow the retention formation 108 to enter the notch 48″. To release the add-in card 40″ the outwardly angled portion 104b of the arm 104 is pulled away from the add-in card 40″ thus releasing the retention formation 108 from the notch 48″.

In a further variation, the retention formation 108 may be constructed without the cam surface 109 uppermost, in which case the add-in card 40″ would be inserted into the female connector 100 and then the carriage part 102 would be moved along the connector 100 into the desired position. The add-in card 40″ would be released by a similar action, that is by moving the carriage part 102 along the connector 100 away from the add-in card 40″.

The above described embodiments are examples only of I/O expansion systems incorporating combinations of connectors and add-in cards designed to cooperate in accordance with the invention. It will be readily understood that there are many other ways in which I/O expansion systems according to the invention may be constructed.

1. An I/O expansion system comprising:
a female connector for operative connection to a baseboard, and
an add-in card having a male connector on a first edge for receipt by the female connector and a notch for receipt of a retention formation of the female connector (10; 100),
wherein it further includes a carriage part movable along the length of the female connector and providing support for the retention formation.

2. An I/O expansion system according to claim 1 wherein it further includes on a surface of the carriage part adjacent the female connector a locking formation, and on an outer surface of the female connector a plurality of co-operating locking formations spaced apart along the length of the female connector, such that the carriage part is lockable with respect to the female connector at a plurality of positions along its length, and wherein the carriage part includes a recess in its upper surface into which in use an edge of the add-in card is received.

3. An I/O expansion system according to claim 2 wherein the locking formation on the carriage part is a protrusion, and the locking formations on the female connector are recesses.

4. An I/O expansion system according to claim 1 wherein the retention formation is pivotable between an operative position in which the retention formation is within the notch on the add-in card and acts to retain the add-in card in the female connector and an inoperative position in which the retention formation is free of the notch on the add-in card and the add-in card can be removed from the female connector, and wherein it further includes an arm connected with the retention formation for pivoting of the retention formation between the operative and inoperative positions.

5. An I/O expansion system according to claim 1 wherein the retention formation is hook shaped.

6. An I/O expansion system according to claim 1 wherein the carriage part includes an upwardly extending arm and the retention formation is an inwardly extending protrusion from the upwardly extending arm, and wherein the upwardly extending arm is resiliently deformable, and the retention formation has a cam surface on its upper side such that when the add-in card is inserted into the female connector the upwardly extending arm bends outwardly to permit the retention formation to ride over a leading edge of the notch and then into the notch to the retain the add-in card in the female connector.

7. An I/O expansion system according to claim 2 wherein the female connector includes a housing which supports a plurality of electrical contacts, and the co-operating locking formations spaced apart along the length of the female connector are provided on an outer surface of the housing and wherein the carriage part is substantially “U” shaped.

8. An I/O expansion system according to claim 2 wherein the female connector includes a housing which supports a plurality of electrical contacts, and a cover which increases the width of the female connector towards its upper surface, and the co-operating locking formations spaced apart along the length of the female connector are provided on an outer surface of the cover, and wherein the carriage part is substantially “C” shaped, and is retained on the female connector by engaging beneath the cover.

9. A female connector for an I/O expansion system according to claim 1.

10. A female connector specifically adapted for both operative connection to a baseboard and receipt of a male edge connector of an add-in card, wherein it includes a carriage part movable along the length of the female connector and providing support for a retention formation specifically adapted to engage in use with a formation on the add-in card to retain the male edge connector of the add-in card in the female connector.
